(19) United States
(12) Patent Application Publication
(10) Pub. No.: US 2025/0002777 A1
(43) Pub. Date: Jan. 2, 2025

(54) SUBTERRANEAN WATER CONTROL USING SWELLABLE ELASTOMERIC PARTICLES

(71) Applicant: Schlumberger Technology Corporation, Sugar Land, TX (US)

(72) Inventors: Valerie Gisele Helene Lafitte, Houston, TX (US); Juan David Estrada Benavides, Sugar Land, TX (US)

(21) Appl. No.: 18/577,823

(22) PCT Filed: Jul. 11, 2022
(86) PCT No.: PCT/US2022/036628

§ 371 Date: Jan. 9, 2024

Related U.S. Application Data
(60) Provisional application No. 63/220,010, filed on Jul. 9, 2021.

(51) Int. Cl. C09K 8/92; E21B 33/138

(52) U.S. Cl. CPC C09K 8/92; E21B 33/138

(57) ABSTRACT

Methods of stimulating a hydrocarbon reservoir are described herein. An aqueous dispersion of elastomeric particles that swell when in contact with water, each particle having a size in a range from about 10 μm to about 1,000 μm, is pumped into the reservoir via a well, and the elastomeric particles are allowed to swell before starting production from the well.

### CROSS-REFERENCE TO RELATED APPLICATIONS

This applications claims the benefit of U.S. Provisional Application No. 63/220,010 entitled “Subterranean Water Control Using Swellable Elastomeric Particles,” filed Jul. 9, 2021, the disclosure of which is incorporated herein by reference in its entirety.

### FIELD

This patent application describes methods and apparatus for controlling subterranean water in hydrocarbon reservoirs. Specifically, processes for deploying swellable elastomeric particles in hydrocarbon reservoirs are described herein.

### BACKGROUND

Hydrocarbon production from subterranean reservoirs is often limited by water intrusion into hydrocarbon flow pathways. Pre-existing water volumes often limit development of hydrocarbon flow continuity in a newly accessed reservoir, and replacement of produced hydrocarbon with water can slow hydrocarbon continuity in a producing reservoir. Water injected into hydrocarbon reservoirs to mobilize hydrocarbon can block the flow of some of that hydrocarbon to a production well.

A number of materials are conventionally placed into hydrocarbon reservoirs to reduce permeability to water. Particles made of material that swells on contact with water or oil, or both, and particles coated with such materials are known. The swelling particles form blockages that impede flow within the reservoir. Special care must be taken, typically, to ensure the particles impede the flow of water, not hydrocarbon.

### SUMMARY

Embodiments described herein provide a method of treating a hydrocarbon reservoir, the method comprising pumping into a well drilled into the reservoir an aqueous dispersion of particles that swell when in contact with water, each particle comprising elastomeric material and having a size in a range from about 10 μm to about 1,000 μm; and allowing the particles to swell before starting production from the well.

Other embodiments described herein provide a method, comprising pumping into a subterranean formation an aqueous dispersion of ground particles that swell when in contact with water, the particles comprising elastomeric material and having been size-selected to fall in a size range from about 10 μm to about 1,000 μm; and allowing the particles to swell in the subterranean formation.

Other embodiments described herein provide a method of treating a hydrocarbon reservoir, the method comprising pumping into a hydrocarbon reservoir an aqueous dispersion of elastomeric particles that swell when in contact with water, the particles having been ground and size-selected to fall in a size range from about 10 μm to about 1,000 μm; and allowing the particles to swell in the hydrocarbon reservoir

### BRIEF DESCRIPTION OF THE DRAWINGS

FIG. 1 is a flow diagram summarizing a method according to one embodiment.

### DETAILED DESCRIPTION

Elastomeric particles are used to control water flows within a hydrocarbon reservoir. The particles are sized to penetrate most flow pathways within a reservoir, and are placed into the reservoir when water control is desired. The elastomeric particles are made of materials that swell slowly in water, and typically not in oil, so the particles that encounter water swell to interlock and block flow of the water toward the producing well. Contrariwise, particles that encounter oil do not contribute to water permeability reduction, and thus do not block flow of oil toward the producing well. The methods described herein can be used for subterranean formations other than hydrocarbon reservoirs.

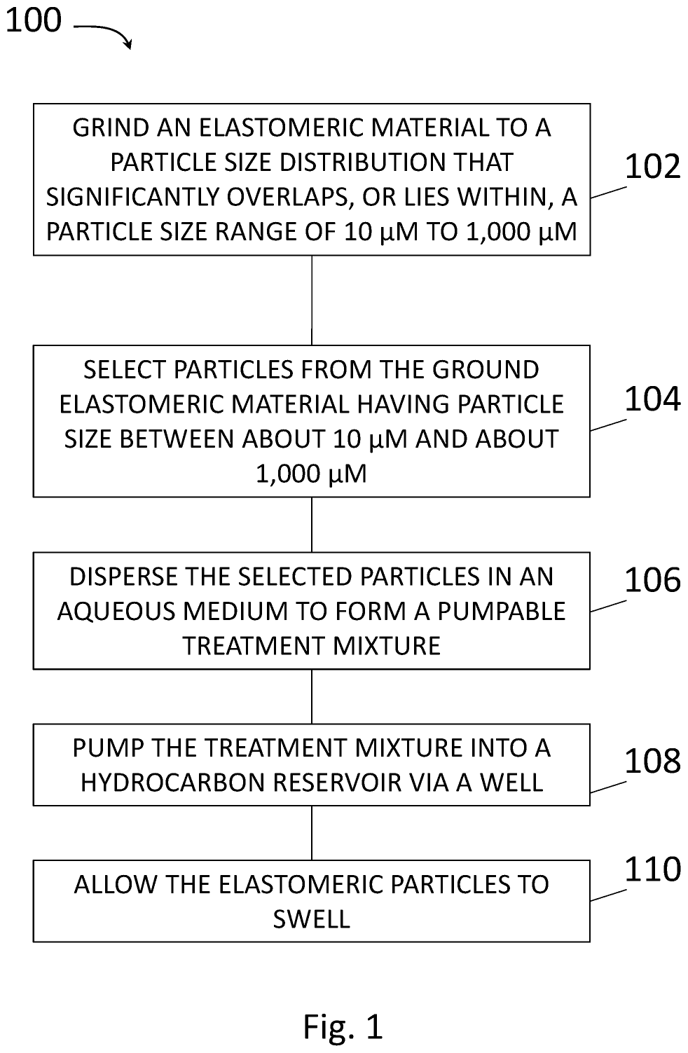

FIG. 1 is a flow diagram summarizing a method 100 according to one embodiment. At 102, an elastomeric material is ground to a particle size distribution that significantly overlaps, or lies within, a particle size range of 10 μm to 1,000 μm. Elastomeric materials that may be used include natural rubber, acrylate butadiene rubber, polyacrylate rubber, isoprene rubber, polybutadiene, nitrile rubber, natural elastomers such as elastin, thermoplastic elastomers such as SIS and SBS block copolymers and thermoplastic urethane, elastomeric proteins such as elastin and resilin, elastolefin, polysulfide rubber, polyether block amides, perfluoro elastomers such as Tecnoflon, Kalrez, Chemraz, and Perlast, chloroprene rubber, butyl rubber, brominated butyl rubber, chlorinated butyl rubber, chlorinated polyethylene, neoprene rubber, styrene butadiene copolymer rubber, sulfonated polyethylene, ethylene acrylate rubber, epichlorohydrin ethylene oxide copolymer, ethylene propylene rubber, polyacrylamides, polyvinyl alcohols, ethylene propylene diene terpolymer rubber, ethylene vinyl acetate copolymer, flourosilicone rubbers, silicone rubbers, fluoro rubbers and fluoroelastomers such as Viton, Fluorel, Aflas, and Dai-El, and combinations thereof. The combinations can be copolymers or multi-polymers of the above materials, or the combinations can be mixtures of particles of different materials, or both. Where a mixture of materials is used, the mixture is usually mixed by extrusion prior to forming particles, as described below.

The materials used herein may be superabsorbent elastomeric materials that guarantee water cannot access the wellbore. The elastomeric materials herein may have an average molecular weight (weight-average molecular weight or number-average molecular weight) of about 10⁵ to 10⁷ Daltons (“Da”), for example about 2×10⁵ Da. Average molecular weight outside this range is usable to certain extent where deviation from the range is not too large. Deviation too far below the range risks excessive deformability, and even flowability, of the elastomeric material, while deviation too far above the range reduces swellability because the material becomes more rigid. Some components of the elastomeric material may have molecular weight outside this range, as long as the average described above is within, or not too far from, the range. There is no absolute boundary to the usable range, since different applications will have different features.

The elastomeric materials can be treated with a treatment fluid prior to use in a subterranean setting to loosen the material and promote liquid absorption upon introduction to the subterranean setting. In some cases, the treatment fluid can be a carrier fluid for transporting the elastomeric materials downhole. The treatment fluid can be an organic fluid, such as an organic solvent or a hydrocarbon solvent, for example mineral oil, an oligomeric or wax material, or a low molecular weight polymeric material. So, for example, an elastomeric material having high average molecular weight, in some cases outside the range described above, can be treated with mineral oil and/or pumped downhole using mineral oil as a transportation fluid. In some cases, the treatment fluid may reduce the average molecular weight of the elastomeric material and/or provide preliminary swelling by introducing smaller molecules into the material to generate space between the larger molecules of the material.

In general, the materials used herein are hydrophilic, even after extension using a hydrocarbon material, although hydrocarbon extension reduces hydrophilicity of the material. Herein, a hydrophilic material is a material that will contact water at an angle less than 90°. For example, if a substrate is coated with one of the elastomeric materials described herein, and a contact angle test with water is formed, the contact angle will be less than 90°, marking the material as hydrophilic. In some cases, a hydrophobic substrate can be impregnated with hydrophilic elastomeric swellable particles to form a slow-release swellable particle source. In such cases, the particle size selected for the elastomeric swellable particles is matched to a pore size of the hydrophobic substrate. Such materials can be used where significant exposure of particles to swelling environments prior to arrival at the placement location is anticipated. In such cases, the hydrophobic substrate can reduce exposure of the elastomeric particles to the swelling environments encountered during transportation.

Pore size for matching swellable particles can be determined by building a model from core samples of the reservoir. One or more cores are taken of a representative portion of the reservoir. Each core is analyzed by NMR, for example using T2 NMR log data, to determine pore sizes in the core, and a pore size model of the reservoir is resolved from the NMR data of the cores based on the position of each core within the reservoir. The pore size model, which is pore size as a function of location in the reservoir, can be used to define a particle size for insertion into a target location of the reservoir. Swellable particles having that particle size can then be produced, and deployment of such swellable particles can be expected to plug pathways within the formation.

The grinding may be performed at low temperatures, for example cryogenic grinding, to ensure stiffness of the elastomeric material during grinding since mechanical stressing of elastomeric materials can increase the temperature of the material and cause flowing. The grinding is typically also performed under an inert atmosphere, such as nitrogen or a noble gas, to avoid any reactivity of hydrocarbon dust that might be generated during the grinding. The grinding can be performed under an atmosphere that is unreactive with the elastomeric material, for example hydrogen. For some elastomeric materials, the ground elastomeric materials may be maintained at a reduced temperature during subsequent handling to minimize reagglomeration.

At 104, the ground elastomeric material is subjected to particle size selection. The ground elastomeric material is engaged with a 10 μm size selection apparatus and a 1,000 μm (1 mm) size selection apparatus to select particles from the ground elastomeric material having particle size between about 10 μm and about 1,000 μm. The size selection may be performed in a single operation. For example the ground elastomeric material may be disposed on an apparatus comprising a 1,000 μm screen located above a 10 μm screen (i.e. a sieve tower). The apparatus may include a shaker, and where screens are used the screens may be tilted, at least partially (e.g. a “folded” screen or conical shape), to create runoff of particles not passed through the screen such that the size selection may be a continuous process. Material not captured between the two screens can be recycled for reagglomeration and regrinding. Material captured between the screens is collected for deployment in a hydrocarbon reservoir. The size selection process is performed at a reduced temperature, and under an inert, or non-reactive, atmosphere to avoid unwanted flowing or agglomeration or any reaction that might be unsafe or might degrade the polymer. In an alternate operation, the size selection may be a sequential process where the ground elastomeric material is subjected to a first size selection at a first particle size followed by a second size selection at a second particle size. The first and second particle sizes are 10 μm and 1,000 μm, which may be applied in any order. The non-selected particle sizes above 1,000 μm and below 10 μm can be recycled for reagglomeration and regrinding.

The particle size distribution produced by the grinding and selection operation will generally feature at least about 99% of the total mass of the particles within the selected range above. Some particles may be larger or smaller than the range set forth above, but larger particles may demobilize at locations other than the desired location within the subterranean setting. Too many such particles can reduce fluid mobility within the subterranean formation. Particles smaller than the desired range can be used in some cases. Where such particles do not swell to a desired size in time to place in the desired location, those particles may flow through the desired location into undesired parts of the subterranean formation, which can complicate reservoir development by redirecting flow pathways.

In some cases, the particles can be formed by coating a smaller particle with a swellable elastomeric material. Such methods can provide better control of particle size and particle size distribution. For example, a monodisperse material of any suitable composition can be coated with an elastomeric material to a target thickness to produce a highly convergent particle size distribution of particles with swellable coatings. The particle size distribution to be used can be targeted based on reservoir characteristics such as porosity and porosity profile. In some cases, particles can be overground to a size smaller than needed at the placement location if swelling prior to placement is planned or anticipated. For example, if the particles are expected to encounter water during transport to the placement location, and are expected to swell somewhat due to that contact, the particles can be ground smaller than the target so the particles do not demobilize at a location other than the desired placement location due to swelling. In other cases, particles can be pre-exposed to a swelling environment prior to pumping downhole.

At 106, the selected elastomeric particles are dispersed in an aqueous medium. The aqueous medium may be water or a brine suitable for injection underground. A dispersant, for example a surfactant, an emulsifier, a casein, or other suitable dispersant or mixture thereof, may be added, with mixing, to promote stable dispersion of the elastomeric material in the aqueous medium. Where a surfactant is used, the surfactant may be a viscoelastic surfactant. In some cases, dispersion can be improved by making a pre-mix of the elastomeric particles in the aqueous medium. The pre-mix is typically highly loaded, and may be a paste or thick liquid. The pre-mix allows the particles to become wet in a low mobility mixture slow to separate. The pre-mix can then be dispersed more easily into a pumpable mixture.

The mixtures formed above are pumped into a hydrocarbon reservoir. Any of the grinding or dispersion may be performed at or near the well site to minimize time between dispersion of the elastomeric material in the aqueous medium and pumping into the reservoir. In some cases, minimizing such time minimizes the opportunity for the dispersion to collapse and the elastomeric material to agglomerate together in warm temperatures. A viscosifier and/or friction reducer can be added to the aqueous dispersion to improve stability and pumpability of the mixture. Some examples include guar, xanthan, and cellulose.

Acids and diversion materials can also be included in the mixture. For acid-responsive formations, the elastomeric particles can be used to design a treatment tailored for long producing intervals that require extended coverage. Depending on their loading into small fluid volumes they can work as a diversion material, to provide acidizing systems to cover the majority of the perforation interval and improve permeability characteristics of the reservoir.

At 108, the mixture formed above is pumped into a hydrocarbon reservoir. The mixture may be pumped from a mixed vessel to maintain dispersion of the elastomeric particles in the aqueous mixture. The mixture is typically pumped into the well to targeted locations that have been perforated to allow flow into the formation. The mixture may be applied continuously to the well or may be applied discontinuously, potentially with targeting measures applied or changed between pumpings. Targeting apparatus such as packers can be used to confine pumping to a targeted location of the well. Selective perforation can also be used between pumpings.

At 110, the mixture is allowed to develop in the well. The elastomeric materials are selected to swell slowly when in contact with water, and to swell little, or not at all, when in contact with hydrocarbon. Given time for swelling to occur, the elastomeric particles grow in volume to plug fissures and microfractures in the vicinity of water volumes in the formation. The elastomeric particles thus reduce movement of water into the productive flow paths while tending not to impede movement of oil into the productive flow paths.

While the foregoing is directed to embodiments of the present invention, other and further embodiments of the present disclosure may be devised without departing from the basic scope thereof, and the scope thereof is determined by the claims that follow.

We claim:

1. A method of treating a hydrocarbon reservoir, the method comprising:
pumping into a well drilled into the reservoir an aqueous dispersion of particles that swell when in contact with water, each particle comprising elastomeric material and having a size in a range from about 10 μm to about 1,000 μm; and
allowing the particles to swell before starting production from the well.

2. The method of claim 1, wherein the particles are made of an elastomeric material selected from the group consisting of natural rubber, acrylate butadiene rubber, polyacrylate rubber, isoprene rubber, chloroprene rubber, butyl rubber, brominated butyl rubber, chlorinated butyl rubber, chlorinated polyethylene, neoprene rubber, styrene butadiene copolymer rubber, sulfonated polyethylene, ethylene acrylate rubber, epichlorohydrin ethylene oxide copolymer, ethylene propylene rubber, ethylene propylene diene terpolymer rubber, ethylene vinyl acetate copolymer, flourosilicone rubbers, silicone rubbers, fluoro rubber, and combinations thereof.

3. The method of claim 1, wherein the particles are made of an elastomeric material selected from the group consisting of natural rubber, acrylate butadiene rubber, polyacrylate rubber, isoprene rubber, polybutadiene, nitrile rubber, natural elastomers such as elastin, thermoplastic elastomers, elastomeric proteins, elastolefin, polysulfide rubber, polyether block amides, perfluoro elastomers, chloroprene rubber, butyl rubber, brominated butyl rubber, chlorinated butyl rubber, chlorinated polyethylene, neoprene rubber, styrene butadiene copolymer rubber, sulfonated polyethylene, ethylene acrylate rubber, epichlorohydrin ethylene oxide copolymer, ethylene propylene rubber, polyacrylamides, polyvinyl alcohols, ethylene propylene diene terpolymer rubber, ethylene vinyl acetate copolymer, flourosilicone rubbers, silicone rubbers, fluoro rubbers and fluoroelastomers, and combinations thereof.

4. The method of claim 1, wherein the particles are made of an elastomeric material having an average molecular weight of about 10⁵ to 10⁷ Daltons.

5. The method of claim 1, wherein the aqueous dispersion also includes one or more of a dispersant, a viscosifier, a friction reducer, an acid, and a diversion material.

6. The method of claim 1, wherein the particles comprise a hydrophilic elastomeric material.

7. The method of claim 6, wherein the particles also comprise a hydrophobic material.

8. The method of claim 7, wherein the hydrophobic material is a substrate or a fluid.

9. The method of claim 6, wherein the hydrophilic elastomeric material is selected from the group consisting of natural rubber, acrylate butadiene rubber, polyacrylate rubber, isoprene rubber, chloroprene rubber, butyl rubber, brominated butyl rubber, chlorinated butyl rubber, chlorinated polyethylene, neoprene rubber, styrene butadiene copolymer rubber, sulfonated polyethylene, ethylene acrylate rubber, epichlorohydrin ethylene oxide copolymer, ethylene propylene rubber, ethylene propylene diene terpolymer rubber, ethylene vinyl acetate copolymer, flourosilicone rubbers, silicone rubbers, fluoro rubber, and combinations thereof.

10. The method of claim 1, wherein the particles are formed by grinding an elastomeric material and size-selecting the particles.

11. A method, comprising:
pumping into a subterranean formation an aqueous dispersion of ground particles that swell when in contact with water, the particles comprising elastomeric material and having been size-selected to fall in a size range from about 10 μm to about 1,000 μm; and
allowing the particles to swell in the subterranean formation.

12. The method of claim 11, wherein the particles are made of an elastomeric material selected from the group consisting of natural rubber, acrylate butadiene rubber, polyacrylate rubber, isoprene rubber, chloroprene rubber, butyl rubber, brominated butyl rubber, chlorinated butyl rubber, chlorinated polyethylene, neoprene rubber, styrene butadiene copolymer rubber, sulfonated polyethylene, ethylene acrylate rubber, epichlorohydrin ethylene oxide copolymer, ethylene propylene rubber, ethylene propylene diene terpolymer rubber, ethylene vinyl acetate copolymer, flourosilicone rubbers, silicone rubbers, fluoro rubber, and combinations thereof.

13. The method of claim 12, wherein the particles are pre-treated using an organic fluid.

14. The method of claim 11, wherein the elastomeric material is an extruded mixture of polymers, and the extruded mixture is ground into particles.

15. The method of claim 11, wherein the elastomeric material comprises polyacrylamide.

16. The method of claim 11, wherein the elastomeric material has an average molecular weight of about 10⁵ to 10⁷ Daltons.

17. The method of claim 11, wherein the aqueous dispersion also includes one or more of a dispersant, a viscosifier, a friction reducer, an acid, and a diversion material.

18. The method of claim 12, wherein the elastomeric material is hydrophilic.

19. A method of treating a hydrocarbon reservoir, the method comprising:
pumping into a hydrocarbon reservoir an aqueous dispersion of elastomeric particles that swell when in contact with water, the particles having been ground and size-selected to fall in a size range from about 10 μm to about 1,000 μm; and
allowing the particles to swell in the hydrocarbon reservoir.

20. The method of claim 19, wherein the elastomeric material is an extruded mixture of polymers, and the extruded mixture is ground into particles.
